(19) United States
(12) Patent Application Publication
(10) Pub. No.: US 2015/0019177 A1
(43) Pub. Date: Jan. 15, 2015

(54) Method of Determining Prestressing Force of Cable Dome Based on Whole Process Analysis of Cable Dome Tensioning and Bearing

(71) Applicant: China Aviation Planning and Construction Development Co., Ltd., Beijing (CN)

(72) Inventors: Jiaqi Ge, Beijing (CN); Guojun Zhang, Beijing (CN); Shu Wang, Beijing (CN); Botao Ma, Beijing (CN); Xingang Liu, Beijing (CN)

(21) Appl. No.: 14/500,272

(22) Filed: Sep. 29, 2014

Related U.S. Application Data
(63) Continuation of application No. PCT/CN2013/073732, filed on Apr. 3, 2013.

(30) Foreign Application Priority Data
Apr. 4, 2012 (CN) 201210095743.2

(51) Int. Cl. G06F 17/50; G06F 17/10

(52) U.S. Cl. CPC G06F 17/50; G06F 17/10
USPC 703/1

(57) ABSTRACT

A method of determining a prestressing force of a cable dome structure based on a cable dome tensioning and bearing whole process analysis, comprising: determining an initial geometry of a cable dome structure according to a construction geometry requirement and a construction function requirement; gradually increasing the prestressing force based on the initial prestressing force until a part of the cables of the cable dome structure exit the task, a ring cable reaches material yield, and the cable dome structure does not carry any load, and conducting a simulation analysis on elastoplasticity and geometrical non-linearity in a whole process of loading the structure by use of a load increment method; drawing a graph of structure displacement-whole bearing process and a graph of stress -whole bearing process; and determining the final design prestressing force of the cable dome structure according to a stable bearing capacity and a structural deformation capacity of the cable dome structure under the action of different times of initial prestressing force obtained based on the graph of structure displacement-whole bearing process and the graph of stress -whole bearing process.

### CROSS-REFERENCE TO RELATED APPLICATIONS

This application is a continuation application of Patent Cooperation Treaty Application No. CN2013/073732, filed on Apr. 3, 2013, which claims priority to and the benefit of the filing of China Patent Application Serial No. 201210095743.2, filed on Apr. 4, 2012, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### FIELD OF THE INVENTION

The present invention relates to a civil engineering structure design method, more particularly, relates to a method of determining a prestressing force of a cable dome structure.

### BACKGROUND OF THE INVENTION

A cable dome structure is a tensegrity structure and in a full tension state. The cable dome structure comprises a continuous cable and a discontinuous pressure bar. The continuous cable, like a tension of the ocean, makes the whole cable dome structure in a continuous tension state. The cable and the cable dome structure almost do not have a natural stiffness before applying a prestressing force on them, that is, the stiffness of them is provided entirely by the prestressing force. A design gist of the cable dome structure is to determine the prestressing force on the cable at various portions of the cable dome structure after determining the cable dome structure system. So far, documents about the cable dome in the global mainly focus on the analysis of mechanical property, and the analysis of prestressing force determination method is limited to a theoretical research on initial prestressing force distribution, for example, calculating the initial prestressing force distribution by use of a force density method, a dynamic relaxation method, a imbalance force iterative method or a concept of integral feasible prestressing force. However, so far, there is no practical cable dome prestressing force determination solution that can be directly applied to engineering practice.

### SUMMARY OF THE INVENTION

A prestressing tension process of a cable dome structure is a process of converting the cable dome structure from a mechanism to a structural system. The design of the cable dome structure needs to not only satisfy requirements of structural bearing capacity and deformation performance, but also satisfy requirements of water and snow discharge construction function and construction geometry after the cable dome is tension-formed. Thereby, providing a feasible and practical prestressing force determination method from the engineering point of view becomes an urgent problem to be solved in the field of cable dome design.

During designing the cable dome, firstly giving the geometry of the construction, and requesting the tension-formed cable dome to substantially keep the given geometry. In an aspect of the present invention, there is provided a method of determining a prestressing force based on a whole process analysis of cable dome tensioning and bearing. The designed cable dome structure by the method can not only satisfy requirements of a structure bearing capacity and a deformation performance, but also satisfy requirements of construction geometry. The method comprises steps of:

(1) determining an initial geometry of a cable dome structure according to a construction geometry requirement (for example, spherical dome, ellipsoid dome, etc.) and a construction function requirement (comprising water and snow discharge). The initial geometry is the geometry of the upper surface of the cable dome when there is no prestressing force and load on the cable dome. According to the design requirement, the final cable dome should have the initial geometry.

(2) conducting a cable dome tensioning simulation analysis (for example, by applying an initial stressing force or a negative temperature on the cable) to determine different prestressing forces P₀ exerted by respective groups of cables, so that the cable dome structure exhibits a structure balance geometry obtained by geometric nonlinear static calculation under the action of the prestressing force P₀ and its self weight.

A tension form-finding simulation analysis on the cable dome structure may be conducted by use of a nonlinear finite element method. In this step, the prestressing force P₀ may be calculated by use of a repeated trial calculation method, a force density method or a dynamic relaxation method, or determined by use of a concept of integral feasible prestressing force.

(3) determining whether the structure balance geometry obtained in the step (2) conforms to the initial geometry, if yes, defining the prestressing force P₀ as an initial prestressing force, if not, modifying the prestressing force Pₒ until the structure balance geometry conforms to the initial geometry.

(4) gradually increasing the prestressing force by using the initial prestressing force as a basic module until a part of the cables of the cable dome structure does not work, a ring cable reaches material yield, and the cable dome structure cannot bear any load, and conducting a simulation analysis on elastoplasticity and geometrical non-linearity in a whole process of loading the structure by use of a load increment method.

(5) drawing a graph of structure displacement-whole bearing process and a graph of stress-whole bearing process based on a simulation analysis result obtained in step (4).

(6) obtaining a stable bearing capacity and a structural deformation capacity of the cable dome structure under the action of different times of initial prestressing force according to the graph of structure displacement-whole bearing process and the graph of stress -whole bearing process.

(7) evaluating whether the structure bearing capacity and the structural deformation capacity under the action of different times of initial prestressing force satisfy a target structure design performance requirements. The target structure design performance requirements in step (7) comprise elastic bearing capacity after considering reasonable safety factor, cable yield bearing capacity and structure damage ultimate bearing capacity.

The target structure design performance requirements at respective stages are determined based on engineering safety property and economical performance and conform to relevant specifications.

(8) determining a reasonable range for a design prestressing force based on an evaluating result of step (7), and selecting a final design prestressing force P within the reasonable range.

In an exemplary embodiment, the method may further comprise steps of:

(9) checking whether the structure balance geometry of the cable dome structure obtained under the combination action of the design prestressing force selected within the reasonable range and a design load conforms to the initial geometry, if not, selecting another design prestressing force within the reasonable range obtained in step (8) and rechecking the structure balance geometry until the structure balance geometry of the cable dome structure conforms to the initial geometry; and

(10) determining the design prestressing force selected in step (9), under the combination action of which and the design load the structure balance geometry of the cable dome structure conforms to the initial geometry, as the final design prestressing force P of the cable dome.

The prestressing force determination is a key point of designing the cable dome structure. The present invention provides a feasible and practical prestressing force determination method from the engineering point of view. The cable dome designed by the method can not only satisfy the requirement of construction geometry, but also satisfy the requirement of structural safety property. Also, the method can be easily understood and practiced by engineering designers.

### BRIEF DESCRIPTION OF THE DRAWINGS

The above and other features of the present invention will become more apparent by describing in detail exemplary embodiments thereof with reference to the accompanying drawings, in which:

FIG. 1 is a flow chart of a method according to an exemplary embodiment of the present invention;

FIG. 2 shows an initial geometry of a cable dome, wherein (a) is a top view of the initial geometry of the cable dome, (b) is a isometric view of the initial geometry of the cable dome, (c) is a cross section view of the initial geometry of the cable dome, in which, 1—outer ridge cable, 2—middle ridge cable, 3—inner ridge cable, 4—tension ring top chord, 5—outer support bar, 6—middle support bar, 7—inner support bar, 8—outer slope cable, 9—middle slope cable, 10—inner slope cable, 11—tension ring bottom chord, 12—middle ring cable, 13—outer ring cable;

FIG. 3a shows a graph of minimum stress of inner ridge cable-whole bearing process of cable dome, wherein horizontal axis X indicates the minimum stress (MPa) of inner ridge cable, vertical axis Y indicates load factor (that is, a ratio of the applied load to the designed load, and the same below);

FIG. 3b shows a graph of maximum stress of outer slope cable-whole bearing process of cable dome, wherein horizontal axis X indicates the maximum stress (MPa) of outer slope cable, vertical axis Y indicates load factor;

FIG. 3c shows a graph of maximum stress of outer ring cable-whole bearing process of cable dome, wherein horizontal axis X indicates the maximum stress (MPa) of outer ring cable, vertical axis Y indicates load factor;

FIG. 3d shows a graph of vertical displacement of tension ring top chord-whole bearing process of cable dome, wherein horizontal axis X indicates the vertical displacement (m) of tension ring top chord, vertical axis Y indicates load factor;

FIG. 4 shows a comparison of a loaded geometry and an initial geometry of a cable dome, wherein a indicates the initial geometry, and b indicates the loaded geometry under the combination action of designed prestressing force P and designed standard load.

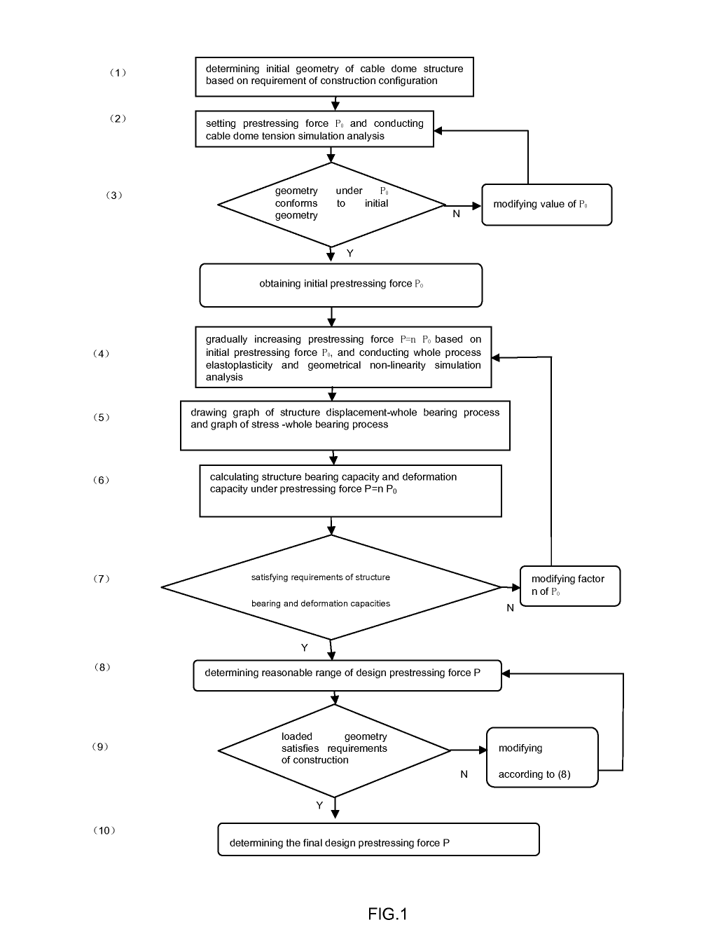

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

### First Embodiment

Hereafter, it will describe in detail a method of the present invention by taking a rib ring cable dome structure as an example. The method may comprise steps of:

(1) determining an initial geometry of a cable dome structure according to a construction geometry requirement and a construction function requirement, wherein the initial geometry is a spherical dome form.

(2) determining a cable dome topology configuration based on the initial geometry, and building up a cable dome calculation model, wherein firstly preliminarily determining cross sections of members of the cable dome, and applying prestressing force on rings of slope cables by applying an initial stressing force on the cable, conducting a cable dome tension simulation analysis by use of a prestressing force quick determination method, and determining the prestressing force P₀ by geometric nonlinear static calculation, so that the cable dome structure exhibits a structure balance geometry obtained by geometric nonlinear static calculation under the action of the prestressing force P₀ and its self weight.

(3) determining whether the structure balance geometry conforms to the initial geometry, if yes, defining the prestressing force P₀ as an initial prestressing force, if not, modifying the prestressing force P₀ and recalculating the structure balance geometry until the structure balance geometry conforms to the initial geometry.

(4) calculating different prestressing forces P₀, 2.5 P₀, 5 P₀, 7.5 P₀ and 10 P₀, . . . , and inputting a prestressing force, conducting a simulation analysis on elastoplasticity and geometrical non-linearity in a whole process of loading the structure by use of a load increment method, and gradually increasing the prestressing force from the initial prestressing force until a part of the cables of the cable dome structure does not work, a ring cable reaches material yield, and the cable dome structure cannot bear any load.

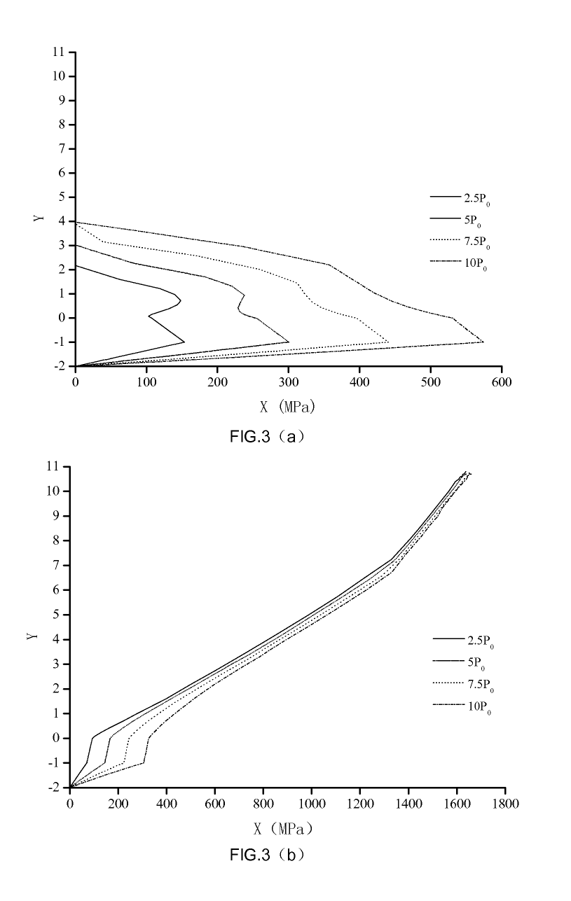

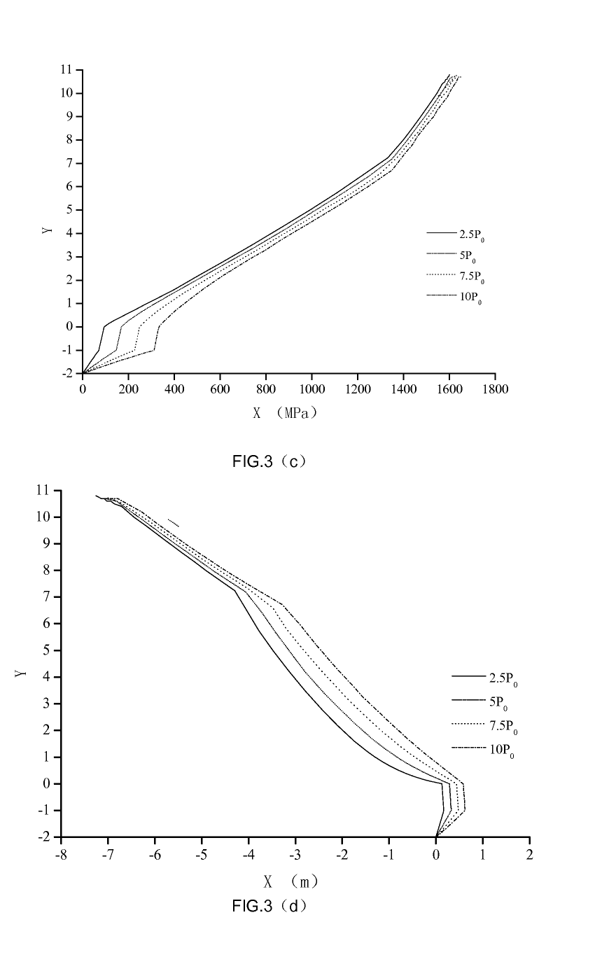

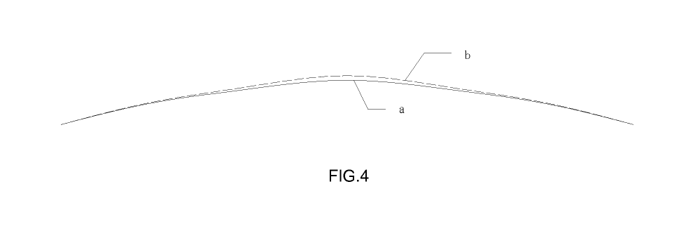

(5) drawing a graph of structure displacement-whole bearing process (as shown in FIG. 3d) and a graph of stress-whole bearing process (as shown in FIGS. 3a, 3b and 3c).

(6) obtaining a stable bearing capacity and a structural deformation capacity of the cable dome structure under the action of different times of initial prestressing force nP₀ according to the graph of structure displacement-whole bearing process and the graph of stress -whole bearing process.

(7) evaluating whether the structure bearing capacity and the structural deformation capacity under the action of different times of initial prestressing force satisfy a target structure design performance requirements.

(8) determining a reasonable range for a design prestressing force based on an evaluating result of step (7), and selecting a final design prestressing force P within the reasonable range.

(9) checking whether the structure balance geometry of the cable dome structure obtained under the combination action of the design prestressing force selected within the reasonable range and a design load conforms to the initial geometry, if not, selecting another design prestressing force within the reasonable range obtained in step (8) and rechecking the structure balance geometry until the structure balance geometry of the cable dome structure conforms to the initial geometry.

(10) determining the design prestressing force selected in step (9), under the combination action of which and the design load the structure balance geometry of the cable dome structure conforms to the initial geometry, as the final design prestressing force P of the cable dome.

Please be noted that the above steps (9) and (10) are not necessary in the present invention. For example, the final design prestressing force P may be one value directly selected within the reasonable range during the step (8).

### Second Embodiment

In order to further describe the method of the present invention, hereafter, it will describe in detail the prestressing force determination method by taking a spherical rib ring cable dome having two rings of ring cable with a span of 100 m as an example, the method may comprise steps of:

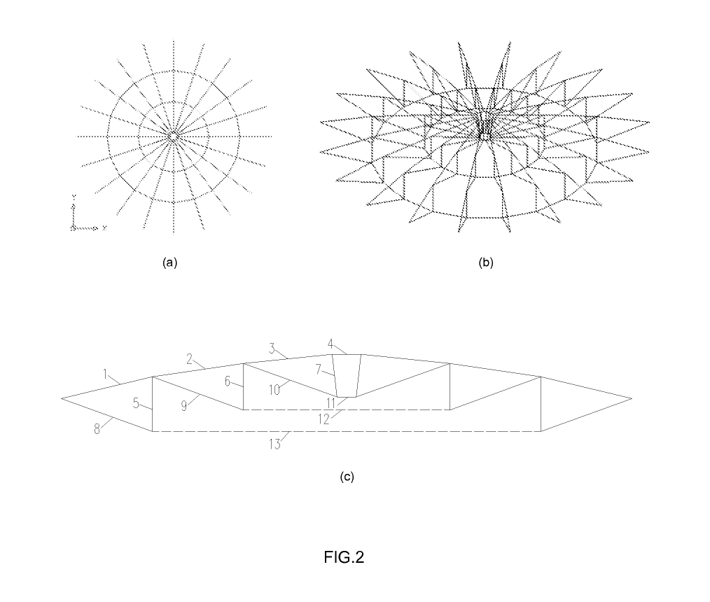

First step: building up an initial geometry of a cable dome structure according to a construction geometry requirement, as shown in FIG. 2;

Second and third steps: taking the initial geometry of the first step as the initial geometry of nonlinear finite element calculation; conducting a structure tension form-finding analysis under the combination action of an initial stress (prestressing force) and its self weight by applying the initial stress on outer, middle and inner slope cables, to obtain a structure balance geometry; and comparing the structure balance geometry to the initial geometry, repeatedly calculating and adjusting the initial stress, and finally obtaining the initial stressing force (or converted into the corresponding prestressing force P₀) satisfying the initial geometry of the construction. The initial stresses of outer, middle and inner slope cables are listed in table 1:

TABLE 1
Initial stress

| | Middle slope | |
|---|---|---|
| Inner slope cable | cable | Outer slope cable |
| 0.000475956 | 0.00095304 | 0.00113676 |

Fourth step: applying different times of initial stressing forces 2.5 P₀, 5 P₀, 7.5 P₀ and 10 P₀ by using the prestressing force P₀ as a basic module. Conducting a simulation analysis on elastoplasticity and geometrical non-linearity in a whole process of loading the structure by use of a load increment method, and gradually increasing the prestressing force from the design load until a part of the cables of the cable dome structure does not work, a ring cable reaches material yield, and the cable dome structure cannot bear any load.

Fifth step: drawing a graph of structure displacement-whole bearing process and a graph of stress-whole bearing process, as shown in FIGS. 3a, 3b, 3c and 3d.

Sixth step: calculating the structure bearing capacity and deformation capacity under the action of n times of prestressing force nP₀, as shown in table 2.

TABLE 2
Relation of the elastic-plastic performance to the prestressing force of the
cable dome structure

| | | Prestressing force P | | | |
|---|---|---|---|---|---|
| | | 2.5P₀ | 5P₀ | 7 .5P₀ | 10P₀ |
| Bearing capacity | Pᵤ | 10.80 | 10.74 | 10.76 | 10.73 |
| | P_{y} | 7.23 | 7.05 | 6.85 | 6.59 |
| | P_{1/40} | 2.90 | 3.60 | 4.38 | 5.10 |
| | Pᵤ/P_{y} | 1.49 | 1.52 | 1.57 | 1.63 |
| Deformation | Dᵤ | 7.26 | 7.09 | 7.05 | 6.97 |
| ductility | Dᵤ/L | 1/13.8 | 1/14.1 | 1/14.2 | 1/14.4 |
| capacity | D_{y} | 4.30 | 4.08 | 3.48 | 3.28 |
| | D_{y}/L | 1/23.3 | 1/24.5 | 1/28.7 | 1/30.5 |
| | Dᵤ/D_{y} | 1.69 | 1.74 | 2.03 | 2.12 |

In which: Pᵤ—elastoplastic (system) failure load coefficient; P_{y}—ring cable yield load coefficient; Dᵤ—failure load deformation, that is, the deformation corresponding to the failure load; D_{y}—ring cable yield load deformation; P_{1/40}—load coefficient when vertical deformation is equal to 1/40 of structure span, L—structure span.

Seventh step: according to requirements of cable dome structure safety control and deformation ductility control, taking a prestressing force within a range of 7.5 P₀˜10.0 P₀ as a safe and reasonable prestressing force to tension the cable dome structure, based on a structural design control target defined by conditions of: elastic plastic stability bearing capacity Pᵤ/P_{y}>1.4, and elastic-plastic deformation capacity Dᵤ/D_{y}>1.8. If the structural design control target is defined by conditions of: ring cable yield load coefficient P_{y}>4.0, and ring cable yield load deformation D_{y}< 1/40 of span, also taking a prestressing force within a range of 7.5 P₀˜10.0 P₀ as a safe and reasonable prestressing force to tension the cable dome structure.

Eighth step: according to the above analysis, taking the prestressing force within the range of 7.5 P₀˜10.0 P₀ as the cable dome design reasonable prestressing force.

Ninth step: taking the prestressing force 8 P₀ as the design prestressing force, calculating the structure balance geometry, as a loaded geometry, under the combination action of the design prestressing force and a design load, and comparing the loaded geometry to the initial geometry, if the difference between a final geometry obtained under the design prestressing force and the design load and the initial geometry is very tine, determining the final geometry to conform to the initial geometry.

Tenth step: based on the result of the ninth step, determining the final design prestressing force P equal to 8.0 P₀, that is, taking 8 times of the values listed in table 1 as the initial prestressing forces (corresponding to the final prestressing force P) of the three rings of slope cables of this cable dome.

Similarly, the ninth step and tenth step are not necessary in the present invention. For example, the final design prestressing force P may be one value directly selected within the reasonable range during the eighth step.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A method of determining a prestressing force based on a whole process analysis of cable dome tensioning and bearing, comprising the steps of:
(1) determining an initial geometry of a cable dome structure according to a construction geometry requirement and a construction function requirement;
(2) conducting a cable dome tensioning simulation analysis to determine different prestressing forces P₀ exerted by respective groups of cables, so that the cable dome structure exhibits a structure balance geometry obtained by geometric nonlinear static calculation under the action of the prestressing force P₀ and its self weight;
(3) determining whether the structure balance geometry obtained in the step (2) conforms to the initial geometry, if yes, defining the prestressing force P₀ as an initial prestressing force, if not, modifying the prestressing force P₀ until the structure balance geometry conforms to the initial geometry;
(4) gradually increasing the prestressing force by using the initial prestressing force as a basic module until a part of the cables of the cable dome structure does not work, a ring cable reaches material yield, and the cable dome structure cannot bear any load, and conducting a simulation analysis on elastoplasticity and geometrical non-linearity in a whole process of loading the structure by use of a load increment method;
(5) drawing a graph of structure displacement-whole bearing process and a graph of stressing force-whole bearing process based on a simulation analysis result obtained in step (4);
(6) obtaining a stable bearing capacity and a structural deformation capacity of the cable dome structure under the action of different times of initial prestressing force according to the graph of structure displacement-whole bearing process and the graph of stressing force-whole bearing process;
(7) evaluating whether the structure bearing capacity and the structural deformation capacity under the action of different times of initial prestressing force satisfy a target structure design performance requirements; and
(8) determining a reasonable range for a design prestressing force based on an evaluating result of step (7), and selecting a final design prestressing force P within the reasonable range.

2. The method according to claim 1, further comprising the steps of:
(9) checking whether the structure balance geometry of the cable dome structure obtained under the combination action of the design prestressing force selected within the reasonable range and a design load conforms to the initial geometry, if not, selecting another design prestressing force within the reasonable range obtained in step (8) and rechecking the structure balance geometry until the structure balance geometry of the cable dome structure conforms to the initial geometry; and
(10) determining the design prestressing force selected in step (9), under the combination action of which and the design load the structure balance geometry of the cable dome structure conforms to the initial geometry, as the final design prestressing force P of the cable dome.

3. The method according to claim 1, wherein, during the step (2), the prestressing force P₀ is determined by use of a repeated trial calculation method, a force density method or a dynamic relaxation method, or determined by use of a concept of integral feasible prestressing force.

4. The method according to claim 1, wherein, during the step (2), conducting a tension form-finding simulation analysis on the cable dome structure by use of a nonlinear finite element method.

5. The method according to claim 1, wherein the target structure design performance requirements in step (7) comprise elastic bearing capacity after considering reasonable safety factor, cable yield bearing capacity and structure damage ultimate bearing capacity.

6. The method according to claim 1, wherein, during the step (2), the cable dome tensioning simulation analysis is performed by applying an initial stress or a negative temperature on the cables.

7. The method according to claim 1, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

8. The method according to claim 2, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

9. The method according to claim 3, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

10. The method according to claim 4, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

11. The method according to claim 5, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

12. The method according to claim 6, wherein, during the step (7), determining an elastoplastic system failure load coefficient Pᵤ, a ring cable yield load coefficient P_{y}, a failure load deformation Dᵤ, and a ring cable yield load deformation D_{y}, and determining a structural design control target defined by conditions of: elastic plastic stability bearing capacity Pᵤ/P_{y}>1.4, and elastic-plastic deformation capacity Dᵤ/D_{y}>1.8.

13. The method according to claim 7, wherein the final prestressing force P is equal to 7.5 to 10 times of the initial prestressing force.

14. The method according to claim 8, wherein the final prestressing force P is equal to 7.5 to 10 times of the initial prestressing force.

15. The method according to claim 1, wherein, during the step (7), a structural design control target is defined by conditions of: ring cable yield load coefficient P_{y}>4.0, and ring cable yield load deformation D_{y}< 1/40 of span.

16. The method according to claim 2, wherein, during the step (7), a structural design control target is defined by conditions of: ring cable yield load coefficient P_{y}>4.0, and ring cable yield load deformation D_{y}< 1/40 of span.

17. The method according to claim 15, wherein the final prestressing force P is equal to 7.5 to 10 times of the initial prestressing force.

18. The method according to claim 17, wherein the final prestressing force P is equal to 7.5 to 10 times of the initial prestressing force.
